(19) United States
(12) Patent Application Publication
(10) Pub. No.: US 2024/0040470 A1
(43) Pub. Date: Feb. 1, 2024

(54) FRONT-END CIRCUITRY FOR CELLULAR VEHICLE-TO-EVERYTHING (C-V2X) STATIONARY OBJECT DETECTION

(71) Applicant: QUALCOMM Incorporated, San Diego, CA (US)

(72) Inventors: Ryan Scott Castro SPRING, San Diego, CA (US); Jing-Hwa CHEN, Sudbury, MA (US); Rakesh JALOTA, Hyderabad (IN); Jungsik PARK, San Diego, CA (US); Pushpak Rajan SARANG, San Diego, CA (US)

(21) Appl. No.: 17/816,602

(22) Filed: Aug. 1, 2022

(51) Int. Cl. H04W 40/20; H04B 1/44; H04W 4/44

(52) U.S. Cl. CPC H04W 40/20; H04B 1/44; H04W 4/44; G07B 15/063

(57) ABSTRACT

Certain aspects of the present disclosure provide apparatus and methods for cellular vehicle-to-everything (C-V2X) stationary object detection. One example radio frequency (RF) front-end circuit generally includes a directional coupler having a first port for coupling to an antenna and having a second port; and a delta switch having a first port coupled to the second port of the directional coupler, having a second port, and having a third port for coupling to a receive path for detection of a stationary object. The RF front-end circuit and methods for C-V2X stationary object detection may allow for concurrent (i) stationary object detection and (ii) C-V2X signal reception or transmission.

### TECHNICAL FIELD

Certain aspects of the present disclosure generally relate to electronic circuits and, more particularly, to techniques and apparatus for cellular vehicle-to-everything (C-V2X) detection of a stationary object.

### BACKGROUND

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division, orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Wireless communication systems have been applied to enable wireless communication services in vehicles. For example, one type of wireless communication, referred to as cellular vehicle-to-everything (C-V2X) communication, provides communication of information from a vehicle to any entity and vice versa over a cellular link. Vehicles that support C-V2X communication may be referred to as C-V2X-enabled vehicles or C-V2X vehicles. A C-V2X vehicle is able to share information about itself, such as its presence, location, direction, speed, etc. with other C-V2X vehicles. Such communications between C-V2X vehicles increases safety and efficiency by allowing the C-V2X vehicles to coordinate and plan driving paths along roadways. However, there exists a need for further improvements in C-V2X wireless communication systems to overcome various challenges.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure generally relate to techniques and apparatus for cellular vehicle-to-everything (C-V2X) detection of a stationary object, such as tollbooth sensing or other electronic payment system sensing.

Certain aspects of the present disclosure provide a front-end circuit configured to support C-V2X technology. The front-end circuit generally includes a directional coupler having a first port for coupling to an antenna and having a second port; and a delta switch having a first port coupled to the second port of the directional coupler, having a second port, and having a third port for coupling to a receive path for detection of a stationary object.

Certain aspects of the present disclosure provide a vehicle. The vehicle generally includes the front-end circuit described herein and the antenna coupled to the first port of the directional coupler.

Certain aspects of the present disclosure provide a method for wireless communication supporting C-V2X. The method generally involves receiving a first radio frequency (RF) signal with an antenna; routing the received first RF signal to a first port of a directional coupler; coupling a portion of the received first RF signal to a second port of the directional coupler; routing the coupled portion of the first RF signal from a first port of a delta switch to a second port of the delta switch; and processing the coupled portion of the first RF signal to detect a stationary object. The method may also include receiving a second RF signal at a third port of the directional coupler, coupling a portion of the received second RF signal to the second port of the directional coupler, and routing the coupled portion of the second RF signal from the first port of the delta switch to a third port of the delta switch.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an example wireless communication system, in which aspects of the present disclosure may be implemented.

FIG. 2 is a block diagram of an example radio frequency (RF) front-end circuit, in which aspects of the present disclosure may be implemented.

FIG. 3A is a block diagram of an example RF front-end circuit supporting cellular vehicle-to-everything (C-V2X) detection of a stationary object, in accordance with certain aspects of the present disclosure.

FIG. 3B illustrates an example path for stationary object detection in the RF front-end circuit of FIG. 3A, in accordance with certain aspects of the present disclosure.

FIG. 3C illustrates example paths for concurrent C-V2X reception and stationary object detection in the RF front-end circuit of FIG. 3A, in accordance with certain aspects of the present disclosure.

FIG. 3D illustrates an example path for a daisy chain line in the RF front-end circuit of FIG. 3A, in accordance with certain aspects of the present disclosure.

FIG. 3E illustrates an example path for C-V2X transmission in the RF front-end circuit of FIG. 3A, in accordance with certain aspects of the present disclosure.

FIG. 4 is a flow diagram illustrating example operations for wireless communication supporting C-V2X, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide a radio frequency (RF) front-end circuit and techniques for cellular vehicle-to-everything (C-V2X) stationary object detection. Stationary object detection may facilitate, for example, tollbooth sensing or other electronic payment system sensing. In some aspects, the techniques may include concurrently (i) detecting a stationary object and (ii) transmitting or receiving C-V2X signals, without affecting coexistence with other vehicular wireless communication standards, such as WiFi 5 GHz. To accomplish this, one example RF front-end circuit generally includes a directional coupler and a delta switch.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### Example Wireless Communication System

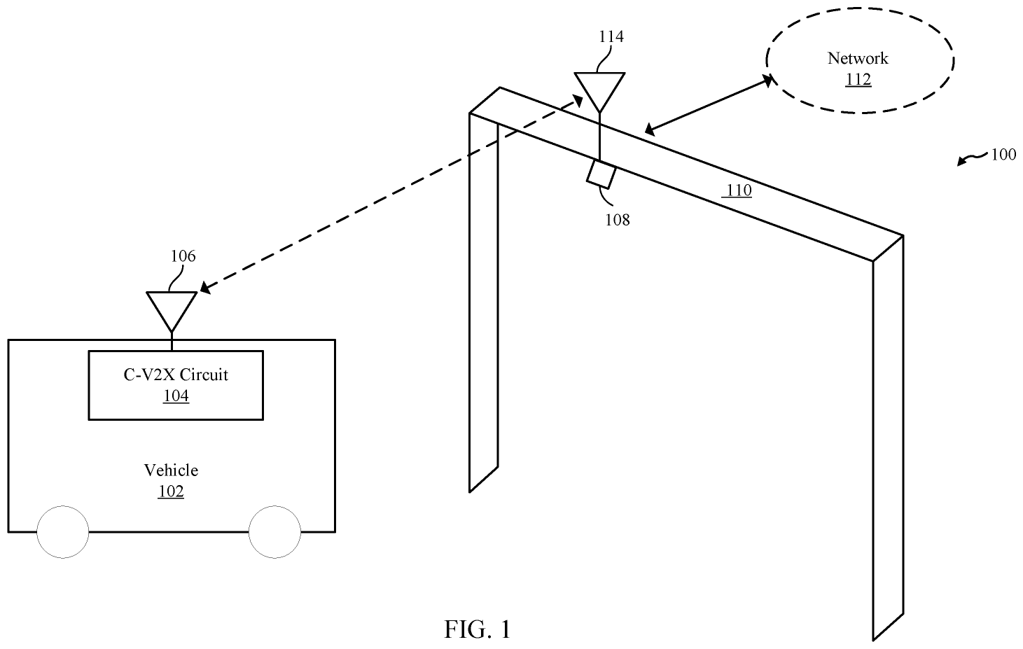

FIG. 1 is a block diagram illustrating an example wireless communication system 100, in which aspects of the present disclosure may be implemented. As illustrated in FIG. 1, the wireless communication system 100 may include a vehicle 102, a stationary object 110, and a network 112.

The vehicle 102 may be a car, a truck, a motorcycle, a boat, or any other means of transportation. The vehicle 102 may include a cellular vehicle-to-everything (C-V2X) circuit 104 coupled to an antenna 106, which may be disposed in and/or on the vehicle. In cases where the antenna 106 is disposed in the vehicle 102, the antenna 106 may extend from the vehicle.

The stationary object 110 may be located along or adjacent to a roadway or waterway to be traversed by the vehicle 102. The stationary object 110 may be used to facilitate electronic payment by the vehicle 102 for the entry into, the continued use of, or the exit from the roadway or waterway. For example, the roadway or waterway may include a tollway, scenic route, park, parking garage, parking lot, channel, marina, or boat slip. The stationary object 110 may include a reader 108 coupled to an antenna 114, In cases where the stationary object 110 is an electronic toll booth, the reader 108 may be a toll tag reader.

The network 112 may be communicatively coupled (wired or wirelessly) to the stationary object 110, and more particularly in some cases, to the reader 108, to the antenna 114, or to a different antenna (not shown). The network 112 may be a wired network (e.g., a wide area network (WAN)), a wireless network, or a combination thereof. In the case of a wireless network, the network may be a New Radio (NR) system (e.g., a 5G NR network), an Evolved Universal Terrestrial Radio Access (E-UTRA) system (e.g., a 4G network), a Universal Mobile Telecommunications System (UMTS) (e.g., a 2G/3G network), or a code division multiple access (CDMA) system (e.g., a 2G/3G network), or may be configured for communications according to an IEEE standard such as one or more of the 802.11 standards, etc.

At certain times (e.g., as the vehicle 102 approaches the stationary object 110), the wireless communication system 100 may also establish a communication link between the C-V2X circuit 104 and the reader 108 (e.g., via the antenna 106 and the antenna 114), which may facilitate electronic payment sensing (e.g., tollbooth sensing). The electronic payment detection may follow an electronic fee payment standard, such as provided by the European Committee for Standardization (CEN, French: Comité Européen de Normalisation) or other standards in different geographical areas. CEN detection may be used in C-V2X communication in order to ensure electronic payment when requested. The C-V2X circuit 104 may perform electronic payment sensing, and may facilitate an electronic payment with the reader 108 when a certain condition is satisfied (e.g., when the C-V2X circuit 104 detects the stationary object 110). The C-V2X circuit 104 may detect the stationary object 110 when the vehicle 102 comes within a certain distance (e.g., 100 feet) from the stationary object 110, or when the vehicle 102 passes by the stationary object 110. The reader 108 may receive the electronic payment information and may then transmit the information to the network 112 to complete the transaction.

### Example RF Front-End Circuit for C-V2X

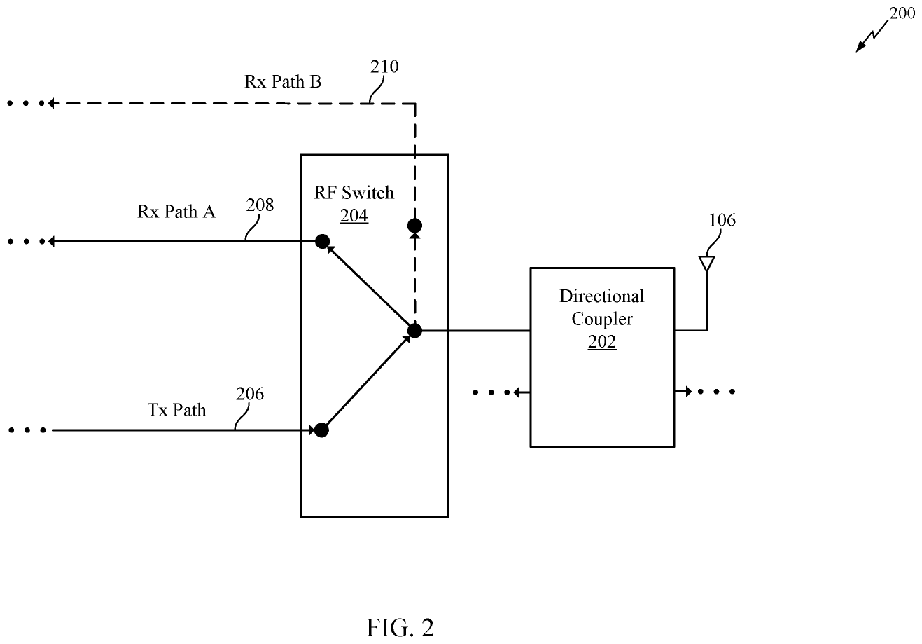

FIG. 2 is a block diagram of an example radio frequency (RF) front-end circuit 200, in which aspects of the present disclosure may be implemented. The RF front-end circuit 200 may support C-V2X and may include one or more antennas (e.g., the antenna 106), a directional coupler 202, an RF switch 204, a transmit (Tx) path 206 (labeled “Tx Path”), and a first receive (RX) path 208 (labeled “Rx Path A”). In some cases, the RF front-end circuit 200 may also include an optional second receive path 210 (labeled “Rx Path B”). The directional coupler 202 may include an input port, a transmitted port, a coupled port, and an isolated port. From the reception perspective, the antenna 106 may be coupled to the input port of the directional coupler 202, and the transmitted port of the directional coupler 202 may be coupled to a port of the RF switch 204. The RF switch 204 may be selectively coupled to the transmit path 206, the first receive path 208, and, optionally, the second receive path 210. The receive paths 208 and/or 210 may be designed, for example, to receive and process C-V2X signals and/or WiFi 5 GHz signals. The coupled port and the isolated port of the directional coupler 202 are not illustrated as being coupled to anything in FIG. 2. The RF front-end circuit 200 may also include additional components that are not shown, such as filters, mixers, amplifiers, impedance matching circuits, and the like in the various receive and transmit paths.

In some cases, the RF front-end circuit 200 may include a filter (e.g., a bulk acoustic wave (BAW) bandpass filter, not shown) coupled to the RF switch 204 (e.g., in the receive path 208 or 210), which by design may prevent the sensing of signals that are outside the bandwidth of the filter (e.g., a C-V2X reception bandwidth or a WiFi 5 GHz reception bandwidth). For example, a reader (e.g., the reader 108) on a stationary object (e.g., the stationary object 110) may transmit an RF signal with signal content in a frequency band outside the bandwidth of the filter of the RF front-end circuit 200 (or with a very wide frequency band having one or more portions outside the existing filter bandwidth). As a result, the RF front-end circuit 200 may be unable to detect the RF signal from the reader, and consequently be unable to detect the stationary object, with the existing filter. In such scenarios, the RF front-end circuit 200 may fail to use an electronic payment system to complete an electronic payment (e.g., a toll payment) with the reader.

To solve this, one option is to widen the filter bandwidth to accommodate the stationary object detection frequency band. However, widening the filter bandwidth may add complexity to the RF front-end circuit and may prohibit WiFi 5 GHz coexistence with C-V2X. As another option, the RF front-end circuit 200 may be designed to include another receive path (not shown) for selectively coupling to the antenna 106 via the RF switch 204 to allow for detection of the stationary object. However, routing to this additional receive path to detect the stationary object may cause the receive path 208 (and the optional receive path 210) to be disconnected, preventing concurrent C-V2X reception and stationary object detection in the RF front-end circuit 200. Instead, the RF front-end circuit 200 may be forced to wait until after completion of the stationary object detection to receive C-V2X signaling.

Accordingly, aspects of the present disclosure provide apparatus and methods for concurrently (i) detecting a stationary object and (ii) receiving or transmitting C-V2X signals. This may be performed without affecting coexistence with other wireless communication standards used in vehicles, such as WiFi 5 GHz.

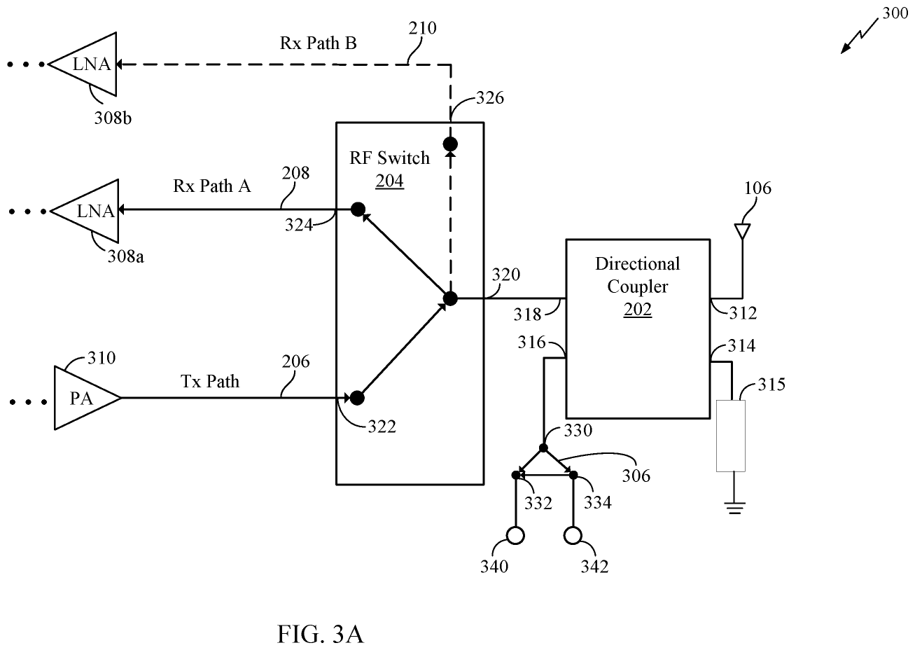

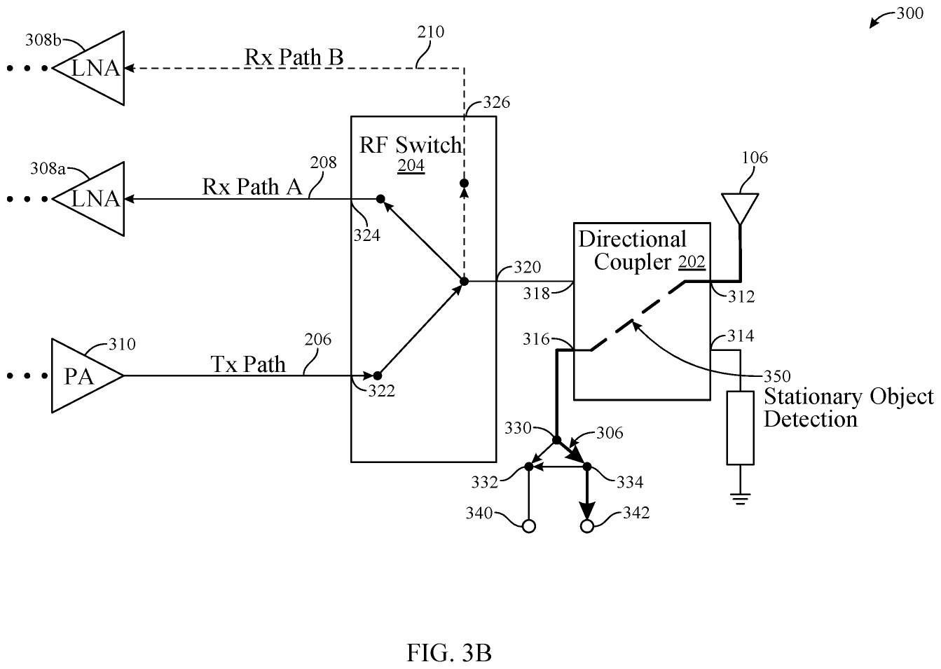

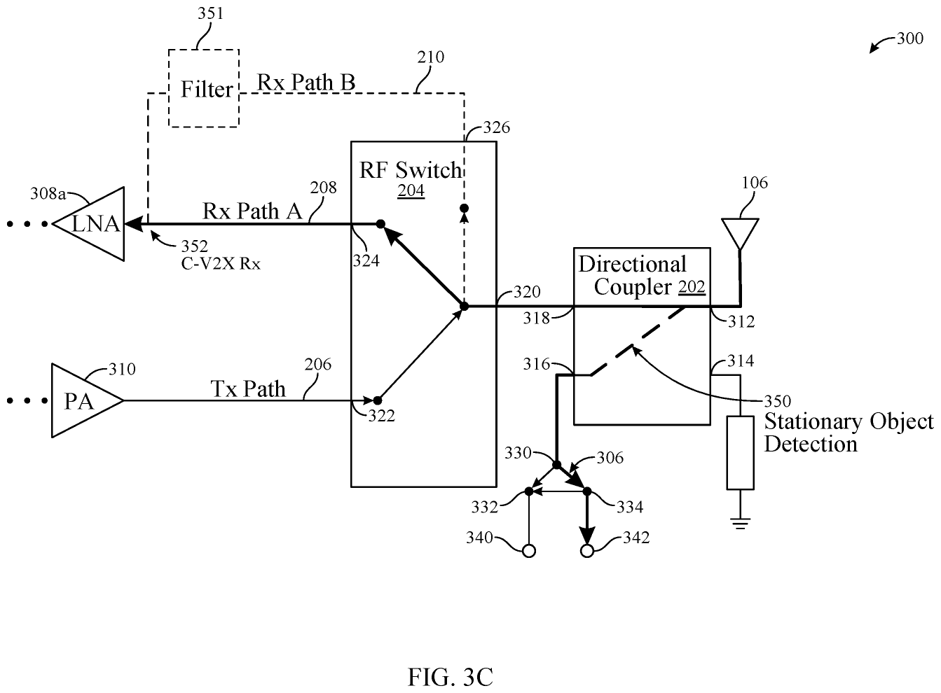

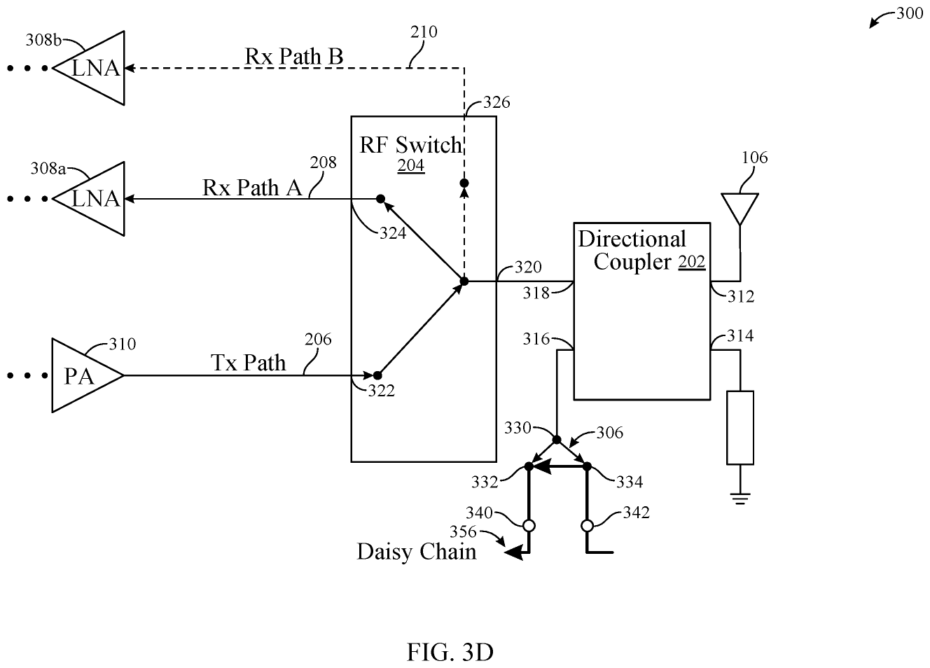

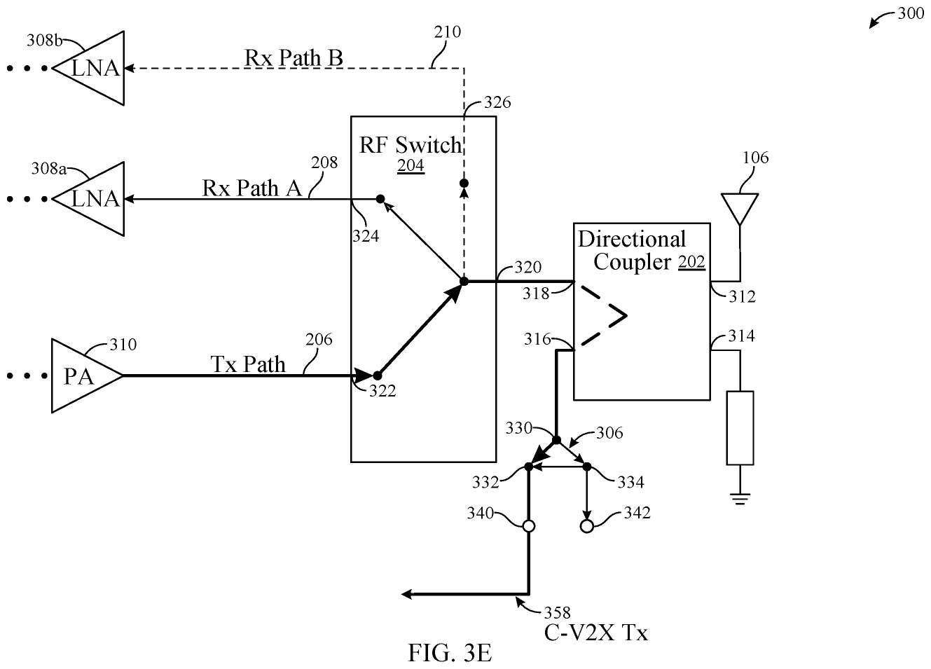

FIG. 3A is a block diagram of an example RF front-end circuit 300 supporting C-V2X detection of a stationary object, in accordance with certain aspects of the present disclosure. The RF front-end circuit 300 may be similar to the RF front-end circuit 200, but may also include a delta switch 306 coupled to the directional coupler 202 for providing power control, daisy chaining, and stationary object detection (e.g., in electronic payment systems, such as toll tag readers). In this manner, concurrent stationary object detection (e.g., CEN detection) and C-V2X reception (or transmission) may be supported.

The delta switch 306 may be implemented as a three-way delta switch, having three ports: a first port 330, a second port 332, and a third port 334. The delta switch 306 may connect any two of the ports 330, 332, and 334 to each other, and may transfer signals in either direction. Thus, the delta switch 306 may couple the first port 330 to the second port 332, the second port 332 to the third port 334, or the third port 334 to the first port 330 to transfer signals in either direction between the ports. In certain aspects, the second port 332 of the delta switch 306 may be coupled to a first terminal 340 of the RF front-end circuit 300, and the third port 334 of the delta switch 306 may be coupled to a second terminal 342 of the RF front-end circuit 300, as illustrated in FIG. 3A. The delta switch 306 may avoid using external or additional switches to share functionality of the directional coupler 202.

The directional coupler 202 may have four ports. The antenna 106 may be coupled to a first port 312 of the directional coupler 202. The directional coupler 202 may include a second port 316 that is coupled to the first port 330 of the delta switch 306. The directional coupler 202 may have a third port 318 coupled to the first port 320 of the RF switch 204. The directional coupler 202 may have a fourth port 314, which may be coupled to a shunt termination impedance 315, as shown.

The first port 320 of the RF switch 204 may be selectively coupled to a second port 322, a third port 324, and, optionally, a fourth port 326 of the RF switch 204. The second port 322 of the RF switch 204 may be coupled to the transmit path 206, which may include a PA 310. The third port 324 of the RF switch 204 may be coupled to the first receive path 208, which may include a low noise amplifier (LNA) 308a. The fourth port 326 of the RF switch 204 may be coupled to the second receive path 210, which may include an LNA 308b as shown in FIG. 3A or any of other various suitable components, such as a filter (e.g., filter 351 shown in FIG. 3C). The RF front-end circuit 300 may also include additional components not shown, such as filters, mixers, amplifiers, impedance matching circuits, and the like in the various receive and transmit paths.

FIG. 3B illustrates an example signal path 350 for stationary object detection in the RF front-end circuit 300 of FIG. 3A, in accordance with certain aspects of the present disclosure. As described above, the stationary object detection may include, for example, electronic fee payment detection, in accordance with an electronic fee payment standard, such as provided by the European Committee for Standardization (CEN, French: Comité Ettropéen de Normalisation) or other standards in different geographical areas. CEN detection may be used in C-V2X communication in order to ensure electronic payment when requested. An electronic payment may be beneficial, for example, when a C-V2X system (e.g., the C-V2X circuit 104) detects a stationary object (e.g., the stationary object 110) and an electronic payment (e.g., toll payment) is requested. As other examples, the electronic payment system may also be used to facilitate payment for the entry or exit of a vehicle (e.g., vehicle 102) into or from a tollway, scenic route, park, parking garage, or parking lot.

In certain aspects, the antenna 106 may receive an RF signal (e.g., in a cellular band for C-V2X). The RF signal may be routed from the antenna 106 to the first port 312 of the directional coupler 202. A portion of the RF signal may be coupled to the second port 316 of the directional coupler 202 and routed to the first port 330 of the delta switch 306. The coupled portion of the RF signal may be routed from the first port 330 of the delta switch 306 to the third port 334 of the delta switch 306 and to the second terminal 342 of the RF front-end circuit 300 and processed to detect a stationary object (e.g., to perform CEN detection). In this manner, the signal path 350 from the antenna 106 through the directional coupler 202 and the delta switch 306 to the second terminal 342 illustrates an example of stationary object detection (e.g., CEN detection) in the RF front-end circuit 300.

FIG. 3C illustrates example signal paths 350, 352 for concurrent C-V2X reception (labeled as “C-V2X Rx”) and stationary object detection in the RF front-end circuit of FIG. 3A, in accordance with certain aspects of the present disclosure.

For certain aspects, the antenna 106 may receive an RF signal, which may have signal content for both C-V2X reception and stationary object detection. The RF signal may be routed from the antenna 106 to the first port 312 of the directional coupler 202. As described above, a first portion of the RF signal may travel along signal path 350 from the antenna 106 through the directional coupler 202 and the delta switch 306 to the second terminal 342, and may be processed to detect a stationary object (e.g., via CEN detection). A second portion of the RF signal may be coupled to the third port 318 of the directional coupler 202. The second portion of the RF signal may be routed from the third port 318 of the directional coupler 202 to the first port 320 of the RF switch 204 and then to the third port 324 of the RF switch 204 (coupled to the first receive path 208), as shown. In this manner, the signal path 352 from the antenna 106 through the first receive path 208 illustrates an example of C-V2X reception in the RF front-end circuit 300. The C-V2X reception may occur concurrently with the stationary object detection in the RF front-end circuit 300, as illustrated by both signal paths 350, 352 in FIG. 3C.

FIG. 3D illustrates an example signal path 356 for a daisy chain through the delta switch 306 in the RF front-end circuit of FIG. 3A, in accordance with certain aspects of the present disclosure.

In certain aspects, a signal (e.g., an RF signal, such as a feedback reception signal) is routed from another circuit into the second terminal 342 of the RF front-end circuit 300. The signal may be routed from the second terminal 342 to the third port 334 of the delta switch 306, to the second port 332 of the delta switch 306, and then to the first terminal 340 of the RF front-end circuit 300. The signal may then be routed from the first terminal 340 to yet another circuit. The signal path 356 through the delta switch 306 illustrates an example of a daisy chain path. The daisy chain path may allow multiple circuits (including the RF front-end circuit 300) to be coupled together.

FIG. 3E illustrates an example signal path 358 for C-V2X transmission (labeled “C-V2X Tx”) in the RF front-end circuit of FIG. 3A, in accordance with certain aspects of the present disclosure. In FIG. 3E, the first terminal 340 of the RF front-end circuit 300 may be coupled to another component, such as a receive chain for power control (not shown), such as a feedback receive chain.

In the signal path 358, an RF signal may travel along the transmit path 206 from the PA 310 to the second port 322 of the RF switch 204. The RF switch 204 may be configured such that the RF signal may be routed from the second port 322 of the RF switch 204 to the first port 320 of the RF switch 204. The third port 318 of the directional coupler 202 may receive the RF signal from the first port 320 of the RF switch 204. A portion of the RF signal may be coupled to the second port 316 of the directional coupler 202 and routed to the first port 330 of the delta switch 306. The coupled portion of the RF signal may be routed from the first port 330 of the delta switch 306 to the second port 332 of the delta switch 306 and the first terminal 340 of the RF front-end circuit 300. The coupled portion of the RF signal may be routed from the first terminal 340 of the RF front-end circuit 300 to another component, for example for transmission or for power control. For other aspects, the coupled portion of the RF signal may be routed from the first terminal 340 to another antenna (not shown) for transmission.

Although not illustrated in FIG. 3E, for certain aspects, the RF front-end circuit 300 may also perform stationary object detection concurrently with C-V2X transmission (e.g., along signal path 358) at low power levels. The signal path 350 from the antenna 106 through the second terminal 342 of the RF front-end circuit 300 in FIG. 3B illustrates an example of stationary object detection. After the stationary object (e.g., the CEN signal) is detected in this concurrent C-V2X transmission and stationary object detection scenario, the C-V2X transmission power may be reduced (i.e., power backoff). Such a reduced transmission power may avoid, or at least decrease, the impact of the C-V2X transmission to stationary object detection for one or more other vehicles.

### Example Operations for Cellular Vehicle-to-Everything

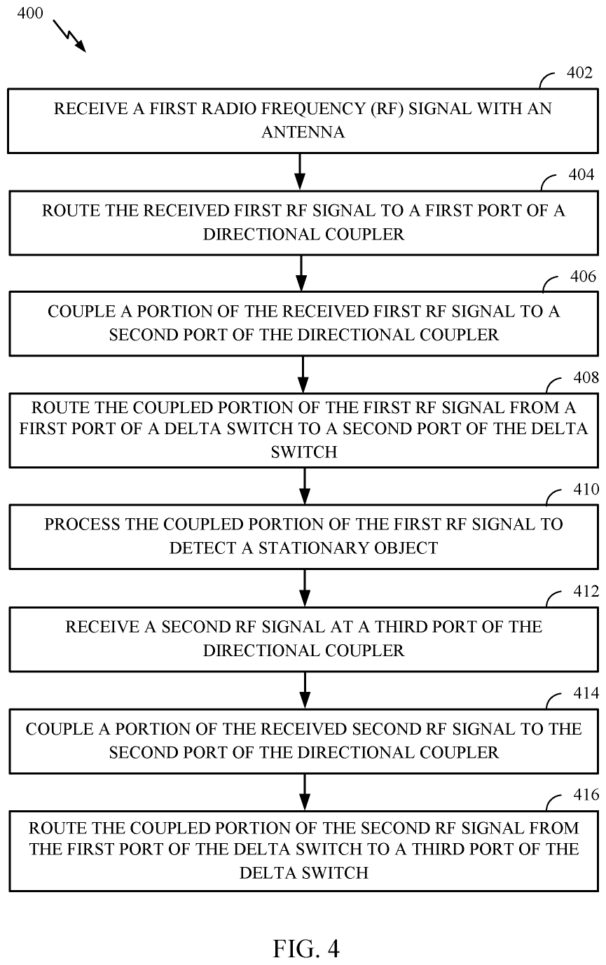

FIG. 4 is a flow diagram illustrating example operations 400 for wireless communication supporting cellular vehicle-to-everything (C-V2X), in accordance with certain aspects of the present disclosure. The operations 400 may be performed by an RF front-end circuit, such as the RF front-end circuit 300 of FIGS. 3A-3E. The flow diagram includes blocks representing the operations 400.

The operations 400 may begin, at block 402, with the RF front-end circuit receiving a first RF signal (e.g., an electronic fee payment signal, such as a CEN signal) with an antenna (e.g., the antenna 106). At block 404, the RF front-end circuit may route the received first RF signal to a first port (e.g., the first port 312) of a directional coupler (e.g., the directional coupler 202).

At block 406, the RF front-end circuit may couple a portion of the received first RF signal to a second port (e.g., the second port 316) of the directional coupler. At block 408, the RF front-end circuit may route the coupled portion of the first RF signal from a first port (e.g., the first port 330) of a delta switch (e.g., the delta switch 306) to a second port (e.g., the third port 334) of the delta switch. At block 410, the RF front-end circuit (e.g., RF front-end circuit 300) may process the coupled portion of the first RF signal (from the second port of the delta switch) to detect a stationary object (e.g., the stationary object 110).

At block 412, the RF front-end circuit may receive a second RF signal at a third port (e.g., the third port 318) of the directional coupler. At block 414, the RF front-end circuit may couple a portion of the received second RF signal to the second port of the directional coupler. At block 416, the RF front-end circuit may route the coupled portion of the second RF signal from the first port of the delta switch to a third port (e.g., second port 332) of the delta switch (e.g., for C-V2X transmission, which may be concurrent with the stationary object detection).

According to certain aspects, the stationary object may include a reader (e.g., the reader 108).

According to certain aspects, the stationary object may be associated with an electronic payment system (e.g., CEN detection).

According to certain aspects, the operations 400 may further involve transmitting the coupled portion of the second RF signal. For example, the coupled portion of the second RF signal may be transmitted via an antenna (e.g., an antenna (not shown) coupled to the first terminal 340 of the RF front-end circuit).

According to certain aspects, the operations 400 may further involve controlling an RF switch (e.g., the RF switch 204) to route the second RF signal from a transmit path for C-V2X (e.g., the transmit path 206) to the third port of the directional coupler. In some cases, the operations 400 may further involve controlling the RF switch to route a remaining portion of the received first RF signal to a first receive path for C-V2X (e.g., the first receive path 208). In other cases, the operations 400 may further involve controlling the RF switch to route another portion of the received first RF signal to a second receive path for C-V2X (e.g., the second receive path 210). For certain aspects, the operations 400 may further involve controlling the RF switch to route the remaining portion of the received first RF signal to an RF filter (e.g., the optional RF filter 351) before the received first RF signal is routed to the first receive path for C-V2X. For certain aspects, detection of the stationary object (e.g., stationary object detection at block 410) is performed concurrently with C-V2X reception (e.g., along path 352 through the directional coupler 202) via the first receive path (e.g., as in FIG. 3C).

According to certain aspects, the first port of the directional coupler may be an input port of the directional coupler. For certain aspects, the second port of the directional coupler may be a coupled port of the directional coupler. According to certain aspects, the third port of the directional coupler may be a transmitted port of the directional coupler.

According to certain aspects, detection of the stationary object (e.g., along path 350 and at block 410) may be performed concurrently with C-V2X reception (e.g., along path 352), as in FIG. 3C, for example.

According to certain aspects, the operations 400 may further involve routing a third RF signal from the second port of the delta switch to the third port of the delta switch or from the third port of the delta switch to the second port (e.g., the path 356 as in FIG. 3D).

### Example Aspects

In addition to the various aspects described above, specific combinations of aspects are within the scope of the disclosure, some of which are detailed below:

Aspect 1: A front-end circuit configured to support cellular vehicle-to-everything (C-V2X) technology, comprising: a directional coupler having a first port for coupling to an antenna and having a second port; and a delta switch having a first port coupled to the second port of the directional coupler, having a second port, and having a third port for coupling to a receive path for detection of a stationary object.

Aspect 2: The front-end circuit of Aspect 1, wherein the stationary object comprises a toll tag reader.

Aspect 3: The front-end circuit of Aspect 1, wherein the stationary object is associated with an electronic payment system.

Aspect 4: The front-end circuit of any of the preceding Aspects, further comprising a radio frequency (RF) switch having a first port coupled to a third port of the directional coupler and having a second port for coupling to a transmit path for C-V2X.

Aspect 5: The front-end circuit of Aspect 4, wherein the RF switch has a third port for coupling to a first receive path for C-V2X.

Aspect 6: The front-end circuit of Aspect 5, wherein the RF switch has a fourth port for coupling to a second receive path for C-V2X.

Aspect 7: The front-end circuit of Aspect 5, wherein the RF switch has a fourth port for coupling to an input of an RF filter, the RF filter having an output coupled to the third port of the RF switch.

Aspect 8: The front-end circuit of any of Aspects 5 to 7, wherein the first port of the directional coupler is an input port of the directional coupler, wherein the second port of the directional coupler is a coupled port of the directional coupler, and wherein the third port of the directional coupler is a transmitted port of the directional coupler.

Aspect 9: The front-end circuit of any of the preceding Aspects, wherein the front-end circuit is configured to support concurrent stationary object detection and C-V2X reception.

Aspect 10: A vehicle comprising the front-end circuit of any of the preceding Aspects, the vehicle further comprising the antenna coupled to the first port of the directional coupler.

Aspect 11: A method of wireless communication supporting cellular vehicle-to-everything (C-V2X), the method comprising: receiving a first radio frequency (RF) signal with an antenna; routing the received first RF signal to a first port of a directional coupler; coupling a portion of the received first RF signal to a second port of the directional coupler; routing the coupled portion of the first RF signal from a first port of a delta switch to a second port of the delta switch; processing the coupled portion of the first RF signal to detect a stationary object; receiving a second RF signal at a third port of the directional coupler; coupling a portion of the received second RF signal to the second port of the directional coupler; and routing the coupled portion of the second RF signal from the first port of the delta switch to a third port of the delta switch.

Aspect 12: The method of Aspect 11, wherein the stationary object comprises a toll tag reader.

Aspect 13: The method of Aspect 11, wherein the stationary object is associated with an electronic payment system.

Aspect 14: The method of any of Aspects 11 to 13, further comprising transmitting the coupled portion of the second RF signal.

Aspect 15: The method of any of Aspects 11 to 14, further comprising controlling a radio frequency (RF) switch to route the second RF signal from a transmit path for C-V2X to the third port of the directional coupler.

Aspect 16: The method of any of Aspects 11 to 15, wherein the first port of the directional coupler is an input port of the directional coupler, wherein the second port of the directional coupler is a coupled port of the directional coupler, and wherein the third port of the directional coupler is a transmitted port of the directional coupler.

Aspect 17: The method of Aspect 15, further comprising controlling the RF switch to route a remaining portion of the received first RF signal to a first receive path for C-V2X.

Aspect 18: The method of Aspect 17, further comprising controlling the RF switch to route another portion of the received first RF signal to a second receive path for C-V2X.

Aspect 19: The method of Aspect 17 or 18, further comprising controlling the RF switch to route the remaining portion of the received first RF signal to an RF filter before the received first RF signal is routed to the first receive path for C-V2X.

Aspect 20: The method of any of Aspects 17 to 19, wherein detection of the stationary object is performed concurrently with C-V2X reception via the first receive path.

Aspect 21: The method of any of Aspects 11 to 19, wherein detection of the stationary object is performed concurrently with C-V2X reception.

Aspect 22: The method of any of Aspects 11 to 21, further comprising routing a third RF signal from the second port of the delta switch to the third port of the delta switch.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation, and details of the methods and apparatus described above without departing from the scope of the claims.

What is claimed is:

1. A front-end circuit configured to support cellular vehicle-to-everything (C-V2X) technology, comprising:
a directional coupler having a first port for coupling to an antenna and having a second port; and
a delta switch having a first port coupled to the second port of the directional coupler, having a second port, and having a third port for coupling to a receive path for detection of a stationary object.

2. The front-end circuit of claim 1, wherein the stationary object comprises a toll tag reader.

3. The front-end circuit of claim 1, wherein the stationary object is associated with an electronic payment system.

4. The front-end circuit of claim 1, further comprising a radio frequency (RF) switch having a first port coupled to a third port of the directional coupler and having a second port for coupling to a transmit path for C-V2X.

5. The front-end circuit of claim 4, wherein the RF switch has a third port for coupling to a first receive path for C-V2X.

6. The front-end circuit of claim 5, wherein the RF switch has a fourth port for coupling to a second receive path for C-V2X.

7. The front-end circuit of claim 5, wherein the RF switch has a fourth port for coupling to an input of an RF filter, the RF filter having an output coupled to the third port of the RF switch.

8. The front-end circuit of claim 4, wherein the first port of the directional coupler is an input port of the directional coupler, wherein the second port of the directional coupler is a coupled port of the directional coupler, and wherein the third port of the directional coupler is a transmitted port of the directional coupler.

9. The front-end circuit of claim 1, wherein the front-end circuit is configured to support concurrent stationary object detection and C-V2X reception.

10. A vehicle comprising the front-end circuit of claim 1, the vehicle further comprising the antenna coupled to the first port of the directional coupler.

11. A method of wireless communication supporting cellular vehicle-to-everything (C-V2X), the method comprising:
receiving a first radio frequency (RF) signal with an antenna;
routing the received first RF signal to a first port of a directional coupler;
coupling a portion of the received first RF signal to a second port of the directional coupler;
routing the coupled portion of the first RF signal from a first port of a delta switch to a second port of the delta switch;
processing the coupled portion of the first RF signal to detect a stationary object;
receiving a second RF signal at a third port of the directional coupler;
coupling a portion of the received second RF signal to the second port of the directional coupler; and
routing the coupled portion of the second RF signal from the first port of the delta switch to a third port of the delta switch.

12. The method of claim 11, further comprising transmitting the coupled portion of the second RF signal.

13. The method of claim 11, further comprising controlling a radio frequency (RF) switch to route the second RF signal from a transmit path for C-V2X to the third port of the directional coupler.

14. The method of claim 13, wherein the first port of the directional coupler is an input port of the directional coupler, wherein the second port of the directional coupler is a coupled port of the directional coupler, and wherein the third port of the directional coupler is a transmitted port of the directional coupler.

15. The method of claim 13, further comprising controlling the RF switch to route a remaining portion of the received first RF signal to a first receive path for C-V2X.

16. The method of claim 15, further comprising controlling the RF switch to route another portion of the received first RF signal to a second receive path for C-V2X.

17. The method of claim 15, further comprising controlling the RF switch to route the remaining portion of the received first RF signal to an RF filter before the received first RF signal is routed to the first receive path for C-V2X.

18. The method of claim 15, wherein detection of the stationary object is performed concurrently with C-V2X reception via the first receive path.

19. The method of claim 11, wherein detection of the stationary object is performed concurrently with C-V2X reception.

20. The method of claim 11, further comprising routing a third RF signal from the second port of the delta switch to the third port of the delta switch.
